(19) United States
(12) Patent Application Publication
(10) Pub. No.: US 2026/0295492 A1
(43) Pub. Date: Oct. 1, 2026

(54) AIR FILTRATION ASSEMBLY WITH AIRFLOW FEEDBACK

(71) Applicant: Apex Brands, Inc., Apex, NC (US)

(72) Inventors: Ralf ZERWECK, Bönnigheim (DE); Michael MOHL, Freudental (DE)

(21) Appl. No.: 19/489,377

(22) PCT Filed: Apr. 30, 2024
(86) PCT No.: PCT/US2024/026983

§ 371 Date: Dec. 2, 2025

Related U.S. Application Data
(60) Provisional application No. 63/472,864, filed on Jun. 14, 2023.

(51) Int. Cl. B01D 46/44; B01D 46/46; B23K 3/08; B23K 26/16; G01F 1/76

(52) U.S. Cl. CPC B01D 46/444; B01D 46/46; B23K 3/08; B23K 26/16; G01F 1/76; B01D 2279/35

(57) ABSTRACT

An air filtration assembly may include an intake which may be repositionable relative to a work tool, a housing which may be operably coupled to the intake and may include a filter, a motor and processing circuitry, an exhaust operably coupled to the housing and an airflow monitoring assembly which may be operably coupled to the intake. The processing circuitry may control the operation of the motor and the airflow monitoring assembly. Air may enter the air filtration assembly at the intake responsive to operation of the motor, before passing through the filter and exiting out the exhaust. The airflow monitoring assembly may include an airflow sensor that may measure a mass flow rate of the air entering the intake and a feedback interface that may indicate an airflow status based on the mass flow rate measurement from the airflow sensor.

### TECHNICAL FIELD

Example embodiments generally relate to air filtration assemblies and, in particular, relate to such assemblies having performance feedback indicators.

### BACKGROUND

Many tasks or processes that may commonly take place in manufacturing or lab settings may generate unwanted byproducts in various forms. For example, processes involving certain materials and chemicals may create waste that may need to be dealt with appropriately either via proper disposal or cleaning. In some cases, the byproducts may be airborne and may require the use of an air filtration assembly to dispose of them accordingly. One such task that may generate airborne byproducts may be soldering. Soldering tools, which are sometimes referred to as soldering irons or soldering guns, are commonly used in electronics manufacturing and repair activities along with other crafts and industries that involve metalwork. Soldering tools are typically used to join metallic items together at a joint by melting a filler metal (i.e., solder) into the joint. A tip portion of the soldering tool may, due to operation of a heater, become hot enough to melt solder that contacts the tip portion. The act of melting the solder, and thus soldering in general, may release gas into the air that may contain volatile organic compounds (VOC's) or other chemicals.

Soldering and other related tasks may often be performed at a workstation indoors. In some cases, the workstation may be located proximate to other workstations and sometimes within the same room. Thus, an air filtration assembly may be employed to filter the air proximate to the workstation where the task may be taking place. Common considerations to make regarding the configuration and use of the air filtration assembly may include ensuring it is adequately sized for the space it is occupying, ensuring it is operating effectively, and improving its overall ease of operation/user experience. Thus, it may be desirable to provide an improved air filtration assembly to address some of the above considerations to create an environment that may be safer for the operator and other potential surrounding workstations.

### BRIEF SUMMARY OF SOME EXAMPLES

In an example embodiment, an air filtration assembly for filtering gas or particles generated responsive to operation of a work tool may be provided. The air filtration assembly may include an intake which may be repositionable relative to the work tool, a housing which may be operably coupled to the intake and may include a filter, a motor and processing circuitry, an exhaust operably coupled to the housing and an airflow monitoring assembly which may be operably coupled to the intake. The processing circuitry may control the operation of the motor and the airflow monitoring assembly. Air may enter the air filtration assembly at the intake responsive to operation of the motor, before passing through the filter and exiting out the exhaust. The airflow monitoring assembly may include an airflow sensor that may measure a mass flow rate of the air entering the intake and a feedback interface that may indicate an airflow status based on the mass flow rate measurement from the airflow sensor.

In another example embodiment, an airflow monitoring assembly for an air filtration assembly for filtering gas or particles generated responsive to operation of a work tool may be provided. The airflow monitoring assembly may include an airflow sensor that may measure a mass flow rate of air entering an intake of the air filtration assembly and a feedback interface that may indicate an airflow status based on the mass flow rate measurement from the airflow sensor. Processing circuitry disposed in the air filtration assembly may determine if the mass flow rate measured by the airflow sensor relative to a predetermined mass flow rate threshold.

In another example embodiment, a work system may be provided. The work system may include a work tool, a workstation at which the work tool may perform a work task, and an air filtration assembly for filtering gas or particles generated responsive to operation of the work tool. The air filtration assembly may include an intake which may be repositionable relative to the work tool, a housing which may be operably coupled to the intake and may include a filter, a motor and processing circuitry, an exhaust operably coupled to the housing and an airflow monitoring assembly which may be operably coupled to the intake. The processing circuitry may control the operation of the motor and the airflow monitoring assembly. Air may enter the air filtration assembly at the intake responsive to operation of the motor, before passing through the filter and exiting out the exhaust. The airflow monitoring assembly may include an airflow sensor that may measure a mass flow rate of the air entering the intake and a feedback interface that may indicate an airflow status based on the mass flow rate measurement from the airflow sensor.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a block diagram of a work system according to an example embodiment;

FIG. 2 illustrates a perspective view of the air filtration assembly from FIG. 1 in accordance with an example embodiment;

FIG. 3 illustrates a perspective view of the air filtration assembly from FIG. 1 in accordance with an example embodiment;

FIG. 4 illustrates a perspective view of the air filtration assembly from FIG. 1 in accordance with an example embodiment; and

FIG. 5 illustrates the functional connections of an airflow monitoring assembly according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, some example embodiments may relate to the provision of an air filtration assembly that includes features that improve its operation. In some cases, an airflow monitoring assembly may be employed to ensure that the air filtration assembly has sufficient airflow into an intake to foster proper filtration of the air. The airflow monitoring assembly may measure the airflow at the intake of the air filtration assembly with a sensor and may indicate the airflow measurement to a user of the air filtration assembly via an airflow feedback interface. However, other strategies and features are also contemplated as described in greater detail below.

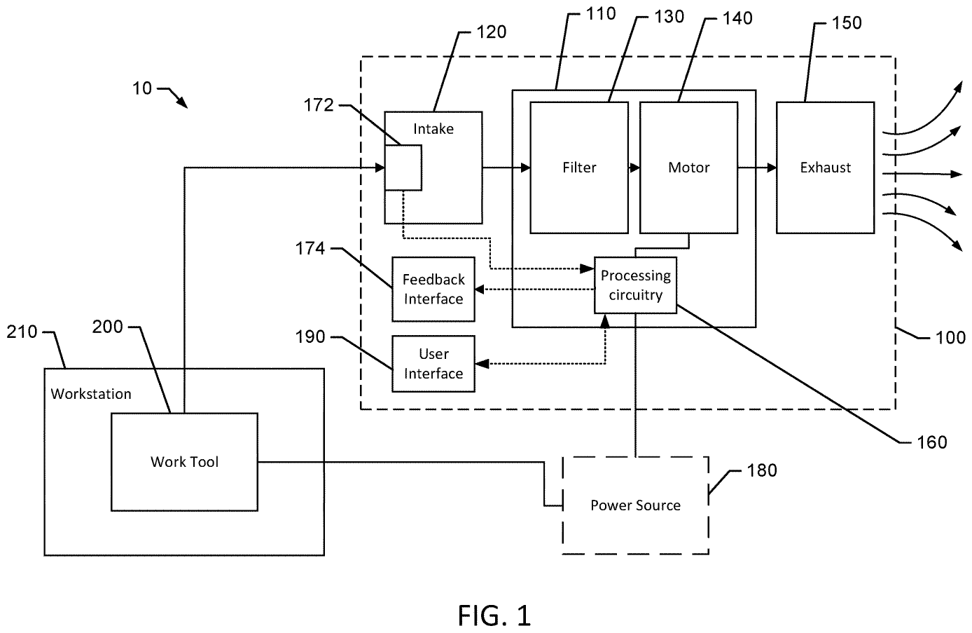

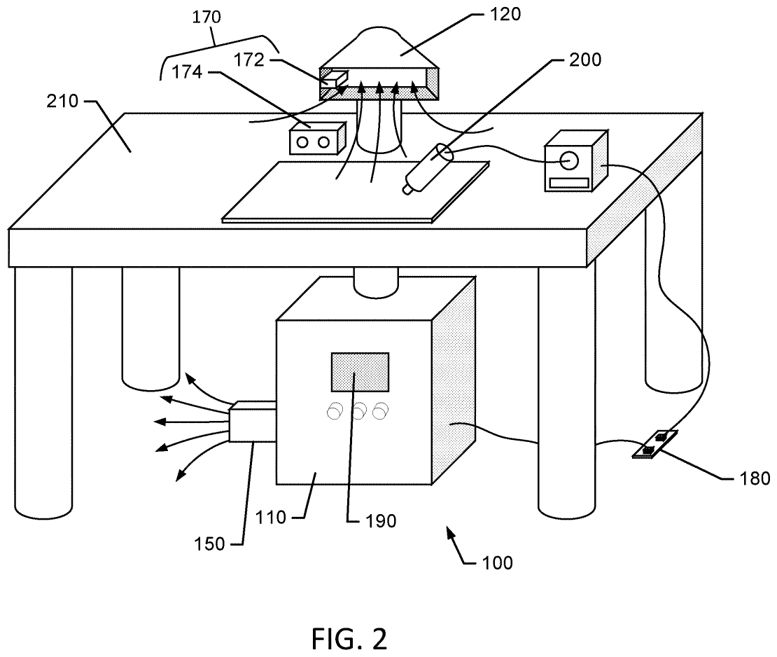

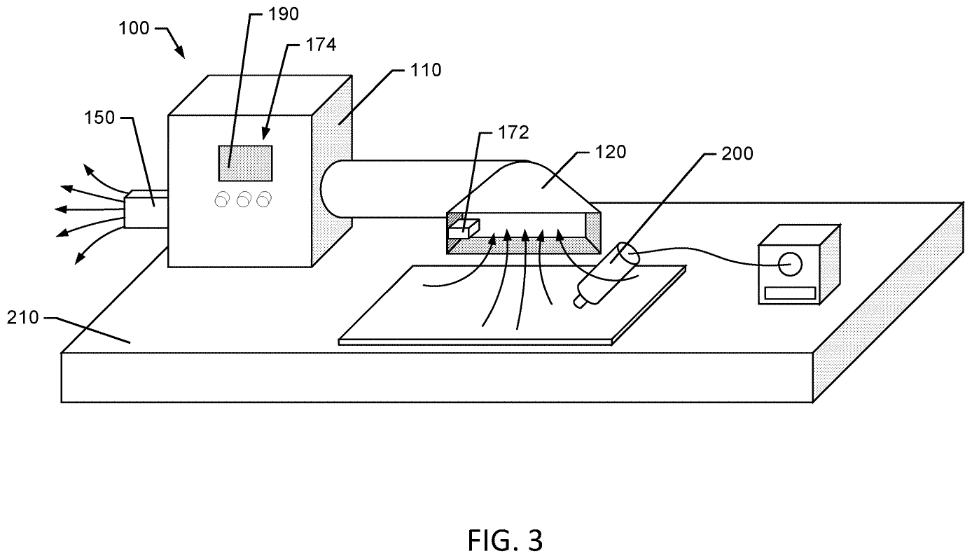

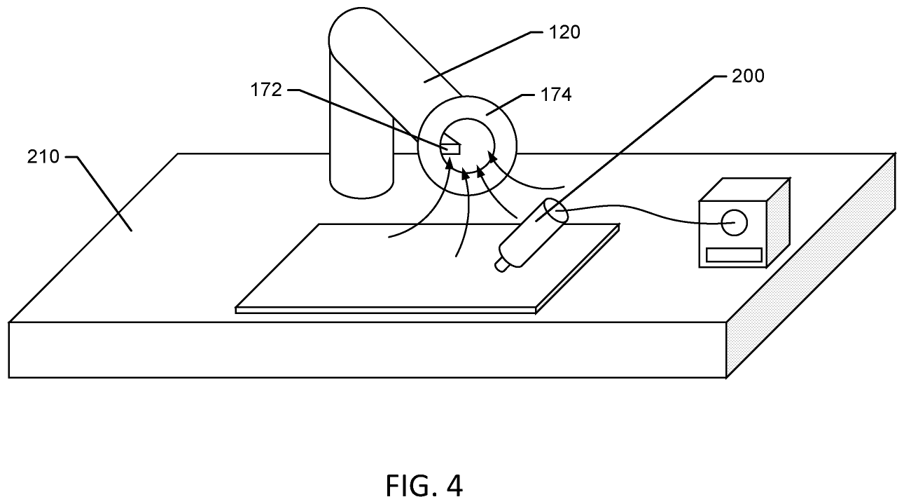

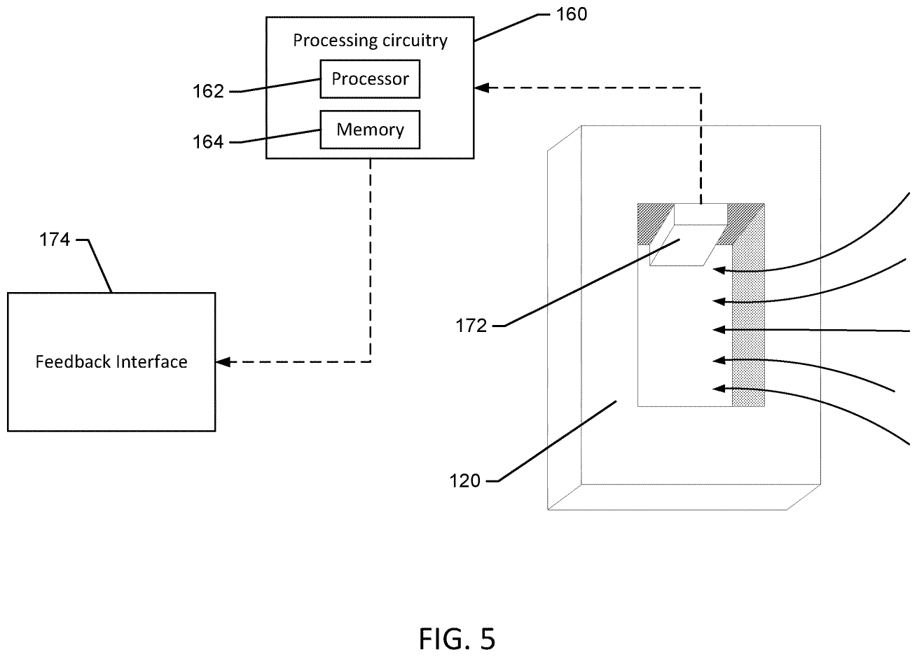

FIG. 1 illustrates a block diagram of a work system 10 according to an example embodiment. FIG. 2 illustrates a perspective view of the air filtration assembly 100 set up at a workstation 210 in accordance with an example embodiment. FIG. 3 illustrates a perspective view of the air filtration assembly 100 set up at a workstation 210 in accordance with an example embodiment. FIG. 4 illustrates a perspective view of the intake 120 of the air filtration assembly 100 set up at a workstation 210 in accordance with an example embodiment. FIG. 5 illustrates the airflow monitoring assembly 170 broken up into its individual components according to an example embodiment.

The work system 10 of FIG. 1 may include an air filtration assembly 100, a work tool 200 and a workstation 210. As shown in the embodiment of FIG. 1, the air filtration assembly 100 may include a housing 110, an intake 120, a filter 130, a motor 140, an exhaust 150 and processing circuitry 160. In some cases, the housing 110 may contain the filter 130, the motor 140 and the processing circuitry 160 within the housing 110. The housing 110 may take on any number of shapes and sizes depending on various design constraints such as the volume of air that the air filtration assembly 100 may need to filter, or in what type of setting the air filtration assembly 100 may be used in. For example, in some cases the air filtration assembly 100 may be a relatively small assembly, and thus the housing 110 may be configured to be disposed on a desktop/workbench. In other cases the air filtration assembly 100 may be slightly larger and thus the housing 110 may be configured to be disposed under a desk/workbench. In still another case, the air filtration assembly 100 may be even larger still and configured to be disposed nearby as a standalone assembly. Thus, the housing 110 may take on different shapes and/or sizes depending on the particular needs and configuration of each embodiment dictated by the environment and the particular use case of the air filtration assembly 100.

The housing 110 may also include the intake 120 and the exhaust 150 operably coupled thereto. In this regard, and as shown in FIG. 1, air may enter the air filtration assembly 100 through the intake 120 before proceeding to pass through the filter 130 responsive to the operation of the motor 140 driving a fan or other mechanism to facilitate airflow through the air filtration assembly 100. The air may exit the air filtration assembly 100 through the exhaust 150 where it may then reenter the immediate surrounding environment, or be directed elsewhere, responsive to having any airborne particles filtered out of the air by the filter 130. In some cases, the filter 130 may be a high efficiency particulate air (HEPA) filter. In some other cases, different levels/forms of filtration may be desired which may necessitate different types of filters for larger or smaller airborne particulates, and even some gaseous compounds.

In an example embodiment, the air filtration assembly 100 may include an airflow monitoring assembly 170 which may measure a mass flow rate of the air entering the intake 120. In this regard, the airflow monitoring assembly 170 may monitor the mass flow rate of the air entering the intake 120 to ensure that the air filtration assembly 100 may be generating sufficient airflow into the intake 120 to promote adequate filtration of the air. In other words, air entering the air filtration assembly 100 through the intake 120 should do so either at or above a predetermined mass flow rate threshold when the air filtration assembly 100 is operating properly. In an example embodiment, the lack of a sufficient mass flow rate of air into the intake 120 could be an indication of a lack of proper function of the air filtration assembly 100, which may be caused by filter depletion, mechanical failure, or any number of reasons.

In some cases, the airflow monitoring assembly 170 may include an airflow sensor 172 and a feedback interface 174. The airflow sensor 172 may be a thermal mass flow sensor that may be disposed at the intake 120 to measure the mass flow rate of the air entering the air filtration assembly 100 through the intake 120. During normal and proper operation of the air filtration assembly 100, the mass flow rate of the entering air should be at or above a predetermined mass flow rate threshold. In an example embodiment, the airflow sensor 172 may communicate the measured mass flow rate to the processing circuitry 160 which may compare the measurement of the mass flow rate of the air to the predetermined mass flow rate threshold. In other words, the processing circuitry 160 may determine if the mass flow rate measured by the airflow sensor 172 may be less than, greater than, or equal to, the predetermined mass flow rate threshold. The processing circuitry 160 may then communicate a signal representative of an airflow status to the feedback interface 174. The feedback interface 174 may indicate a positive airflow status to the user of the air filtration assembly 100 responsive to the measured mass flow rate being equal to or exceeding the predetermined mass flow rate threshold. On the other hand, the feedback interface 174 may indicate a negative airflow status to a user of the air filtration assembly 100 responsive to the measured mass flow rate being less than the predetermined mass flow rate threshold. In some cases, the predetermined mass flow rate threshold may be defined by a user of the air filtration assembly 100, but in most example embodiments, the predetermined mass flow rate threshold may be set and programmed during the manufacturing of the air filtration assembly 100.

The air filtration assembly 100 may be powered by a power source 180 which, according to an example embodiment, may be a source of electrical energy such as a battery or a connection to mains power. Operation of the air filtration assembly 100 may be controlled by the processing circuitry 160 which may be operably coupled to the power source 180 to control the delivery of power to the motor 140 accordingly. In this regard, the processing circuitry 160 may also be operably coupled to a user interface 190 that, in some cases, may be disposed at the housing 110. The user interface 190 may be operable by a user to change certain operating parameters of the air filtration assembly 100, such as powering on/off the air filtration assembly 100 and changing an operating speed of the motor 140, among others. In some embodiments of the air filtration assembly 100, the user interface 190 may also operate as the feedback interface 174, as shown in FIG. 3. In such cases, the user interface 190 should be easily visible to the user of the air filtration assembly 100. The processing circuitry 160 may control the operation of the air filtration assembly 100 automatically responsive to input from the airflow monitoring assembly 170 and without user input from the user interface 190. For example, responsive to the measured mass flow rate being less than the predetermined mass flow rate threshold, the processing circuitry 160 may automatically increase an operating speed of the motor 140 to compensate for the deficiency in the airflow. In other cases, the processing circuitry 160 may notify the user to change the filter 130 responsive to the mass flow rate being less than the predetermined mass flow rate threshold, since a clogged filter 130 may cause the deficiency in the measured mass flow rate. Other causes of the decreased mass flow rate may be possible as well, such as a leak in the intake 120, the length of the intake 120, and any debris disposed in the intake 120. Thus, the processing circuitry 160 may notify the user to check for any or all of these conditions as well, responsive to the mass flow rate being less than the predetermined mass flow rate threshold. In another example embodiment, the processing circuitry 160 may operate the air filtration assembly 100 at a set operating speed for specific time intervals responsive to user input at the user interface 190 selecting such a mode of operation.

The processing circuitry 160 may be configured to provide electronic control inputs to one or more functional units of the air filtration assembly 100 and to process data received at or generated by the one or more functional units of the air filtration assembly 100. Thus, the processing circuitry 160 may be configured to perform data processing, control function execution and/or other processing and management services according to an example embodiment. In some embodiments, the processing circuitry 160 may be embodied as a chip or chip set. In other words, the processing circuitry 160 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 160 may therefore, in some cases, be configured to implement an embodiment of the present invention on a single chip or as a single “system on a chip.” As such, in some cases, a chip or chipset may constitute means for performing one or more operations for providing the functionalities described herein.

FIG. 5 depicts an example embodiment of the airflow monitoring assembly 170 according to an example embodiment. The processing circuitry 160 may include one or more instances of a processor 162 and memory 164 that may be in communication with or otherwise control other components or modules that interface with the processing circuitry 160. As such, the processing circuitry 160 may be embodied as a circuit chip (e.g., an integrated circuit chip) configured (e.g., with hardware, software or a combination of hardware and software) to perform operations described herein. In some embodiments, the processing circuitry 160 may be embodied as a portion of an onboard computer housed in the housing 110 of the air filtration assembly 100 to control operation of the assembly.

In some other cases, the user interface 190 may not be disposed at the housing 110 and may instead be disposed at a personal electronic device of the user. In this regard, the user may be able to configure the operation of the air filtration assembly 100 wirelessly from a personal electronic device such as a smart phone, a tablet, or a personal computer, any of which may act as the user interface 190 in such embodiments. The user interface 190 may be in communication (i.e. either wirelessly or by wire) with the processing circuitry 160 to receive an indication of a user input at the user interface 190 and/or to provide an audible, visual, tactile or other output to the user. As such, the user interface 190 may include, for example, a display, one or more switches, lights, buttons or keys, speaker, and/or other input/output mechanisms. However, more complex interface mechanisms could be provided in some cases. In some cases, the processing circuitry 160 may control the operating speed of the motor 140 based on input provided to the user interface 190 of the air filtration assembly 100.

FIGS. 1-4 also depict a work tool 200 and a workstation 210, which the air filtration assembly 100 may be operably coupled to and/or disposed proximate to. In this regard, the workstation 210 may be a table, desk, workbench or any other sort of structure at which a user may perform a work task. In some cases, the workstation 210 may not include a structure at all, and may simply be a general area in which the work tool 200 may be disposed. The work tool 200 may be any number of a variety of tools depending on a task that is desired to be accomplished. For example, the work tool 200 may be a soldering tool, a laser cutting tool, a 3D printer, an injection molding tool, a mill, a lathe, a power saw or many other types of tools commonly used in manufacturing and engineering. For the purposes of illustration and explanation of the components and associated structures of the air filtration assembly 100, the work tool 200 may be a soldering tool.

In some cases, the air filtration assembly 100 may be one assembly amongst others in a larger air filtration system 220. In such cases, the air filtration system 220 may include a plurality of air filtration assemblies 100 perhaps disposed at a plurality of workstations 210. In such cases, the air filtration system 220 may include a main assembly 230 and a plurality of subsidiary assemblies 240. The main assembly 230 and the subsidiary assemblies 240 may each be an air filtration assembly 100, but the main assembly 230 may be the only air filtration assembly 100 in the air filtration system 220 to include the processing circuitry 160. In this regard, each of the subsidiary assemblies 240 may be configured to communicate with the processing circuitry 160 at the main assembly 230 either wirelessly or by wire. Similar to the functionality described above, if the airflow monitoring assembly 170 disposed at the intake 120 of any of the main assembly 230 or the subsidiary assemblies 240 were to detect a mass flow rate of the air entering the main assembly 230 or the subsidiary assemblies 240 that failed to meet or exceed the predetermined mass flow rate threshold, then the processing circuitry 160 at the main assembly 230 signal to the feedback interface 174 disposed where the particular subsidiary assembly 240 detected the deficient mass flow rate.

In an example embodiment, such as the one shown in FIG. 2, the feedback interface 174 may be disposed within the user's field of view while they may be using the work tool 200. As such, the user may be aware of the airflow status at all times during the operation of the work tool 200 so that if the mass flow rate of the air drops below the predetermined mass flow rate threshold, the user may be able to decide to cease operation of the work tool 200 and address the mass flow rate prior to resuming operation of the work tool 200. As shown in FIG. 2, The feedback interface 174 of some embodiments may include a first light and a second light, and may be disposed proximate to the work tool 200. In this regard, responsive to the mass flow rate being greater than or equal to the predetermined mass flow rate threshold, the feedback interface 174 may indicate a positive airflow status by illuminating the first light. In some cases, the first light may be a green light, which may indicate to the operator that the air filtration assembly 100 may be generating adequate airflow into the intake 120. On the other hand, responsive to the mass flow rate being less than the predetermined mass flow rate threshold, the feedback interface 174 may indicate a negative airflow status by illuminating the second light. In this regard, the second light may be a red light, which may indicate to the operator that the air filtration assembly 100 may not be generating adequate airflow into the intake 120. In an example embodiment, the feedback interface 174 may include a third light, which may be used to indicate that the measured mass flow rate is close to, or within a specified range of, the predetermined mass flow rate threshold. In such cases, the third light may be yellow which may indicate to the operator that the air filtration assembly 100 may be in need of service (e.g. a filter change) soon.

FIG. 4 depicts an example embodiment where the feedback interface 174 may be embodied as a ring-shaped light disposed at the intake 120. In this regard, the feedback interface 174 may be an LED light capable of changing its color based on signals received from the processing circuitry 160. In some cases, the ring-shaped light may extend entirely around an opening into the intake 120 through which air may enter the air filtration assembly 100. In this regard, with the ring-shaped light disposed around the opening of the intake 120, the feedback interface 174 may inherently be disposed proximate to the work tool 200 and well within the user's field of view. Thus, responsive to the measured mass flow rate being greater than or equal to the predetermined mass flow rate threshold, the feedback interface 174 may indicate a positive airflow status by illuminating the ring-shaped light with a first color. In some cases, the first color may be green, which may indicate to the operator that the air filtration assembly 100 may be generating adequate airflow into the intake 120. On the other hand, responsive to the mass flow rate being less than the predetermined mass flow rate threshold, the feedback interface 174 may indicate a negative airflow status by illuminating the ring-shaped light with a second color. In this regard, the second color may be red, which may indicate to the operator that the air filtration assembly 100 may not be generating adequate airflow into the intake 120. In an example embodiment, the ring-shaped light may shift from the first color to the second color via a third color responsive to the mass flow rate decreasing below the predetermined mass flow rate threshold over time. In some cases, the third color may be yellow. Say for example during the operation of the work tool 200 and the air filtration assembly 100, the air filtration assembly 100 starts out with a measured mass flow rate of air into the intake 120 that is above the predetermined mass flow rate threshold, and that the measured mass flow rate decreases over the duration of its use. In such cases, the ring-shaped light may transition its color from the first color, or green, to the second color, or red, via the third color, or yellow, gradually with a same rate of change as the measured mass flow rate itself. In another example embodiment, the ring-shaped light may illuminate white light when the airflow monitoring assembly 170 may not be actively measuring the mass flow rate of the air into the intake 120. Accordingly, the user may use the ring-shaped light to see their task better during operation of the work tool 200.

Some example embodiments may provide for an air filtration assembly for filtering gas or particles generated responsive to operation of a work tool. The air filtration assembly may include an intake which may be repositionable relative to the work tool, a housing which may be operably coupled to the intake and may include a filter, a motor and processing circuitry, an exhaust operably coupled to the housing and an airflow monitoring assembly which may be operably coupled to the intake. The processing circuitry may control the operation of the motor and the airflow monitoring assembly. Air may enter the air filtration assembly at the intake responsive to operation of the motor, before passing through the filter and exiting out the exhaust. The airflow monitoring assembly may include an airflow sensor that may measure a mass flow rate of the air entering the intake and a feedback interface that may indicate an airflow status based on the mass flow rate measurement from the airflow sensor.

In some cases, the air filtration assembly described above may be augmented or modified by altering individual features mentioned above or adding optional features. The augmentations or modifications may be performed in any combination and in any order. For example, in some cases, the processing circuitry may determine if the mass flow rate measured by the airflow sensor relative to a predetermined mass flow rate threshold. In an example embodiment, the feedback interface may include a first light and a second light and may be disposed proximate to the work tool. In some cases, responsive to the mass flow rate being greater than or equal to the predetermined mass flow rate threshold, the feedback interface may indicate a positive airflow status by illuminating the first light. In an example embodiment, responsive to the mass flow rate being less than the predetermined mass flow rate threshold, the feedback interface may indicate a negative airflow status by illuminating the second light. In some cases, responsive to the mass flow rate being less than the predetermined mass flow rate threshold, the processing circuitry may automatically increase an operating speed of the motor. In an example embodiment, the feedback interface may include a ring-shaped light and may be disposed proximate to the intake. In some cases, responsive to the mass flow rate being greater than or equal to the predetermined mass flow rate threshold, the feedback interface may indicate a positive airflow status by illuminating the ring-shaped light with a first color. In an example embodiment, responsive to the mass flow rate being less than the predetermined mass flow rate threshold, the feedback interface may indicate a negative airflow status by illuminating the ring-shaped light with a second color. In some cases, the ring-shaped light may shift from the first color to the second color via a third color responsive to the mass flow rate decreasing below the predetermined mass flow rate threshold over time. In an example embodiment, the processing circuitry may notify a user to change the filter responsive to the mass flow rate being less than the predetermined mass flow rate threshold. In some cases, the airflow sensor may be a thermal mass flow sensor. In an example embodiment, the work tool may be a soldering tool.

Some example embodiments may provide for an airflow monitoring assembly for an air filtration assembly for filtering gas or particles generated responsive to operation of a work tool. The airflow monitoring assembly may include an airflow sensor that may measure a mass flow rate of air entering an intake of the air filtration assembly and a feedback interface that may indicate an airflow status based on the mass flow rate measurement from the airflow sensor. Processing circuitry disposed in the air filtration assembly may determine if the mass flow rate measured by the airflow sensor relative to a predetermined mass flow rate threshold.

Some example embodiments may provide for a work system. The work system may include a work tool, a workstation at which the work tool may perform a work task, and an air filtration assembly for filtering gas or particles generated responsive to operation of the work tool. The air filtration assembly may include an intake which may be repositionable relative to the work tool, a housing which may be operably coupled to the intake and may include a filter, a motor and processing circuitry, an exhaust operably coupled to the housing and an airflow monitoring assembly which may be operably coupled to the intake. The processing circuitry may control the operation of the motor and the airflow monitoring assembly. Air may enter the air filtration assembly at the intake responsive to operation of the motor, before passing through the filter and exiting out the exhaust. The airflow monitoring assembly may include an airflow sensor that may measure a mass flow rate of the air entering the intake and a feedback interface that may indicate an airflow status based on the mass flow rate measurement from the airflow sensor.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. An air filtration assembly for filtering gas or particles generated responsive to operation of a work tool, the air filtration assembly comprising:
an intake repositionable relative to the work tool;
a housing operably coupled to the intake, the housing comprising a filter, a motor and processing circuitry;
an exhaust operably coupled to the housing; and
an airflow monitoring assembly operably coupled to the intake,
wherein the processing circuitry is configured to control the operation of the motor and the airflow monitoring assembly,
wherein air enters the air filtration assembly at the intake responsive to operation of the motor, before passing through the filter and exiting out the exhaust,
wherein the airflow monitoring assembly comprises:
an airflow sensor that measures a mass flow rate of the air entering the intake, and
a feedback interface that indicates an airflow status based on the mass flow rate measured by the airflow sensor.

2. The air filtration assembly of claim 1, wherein the processing circuitry determines the mass flow rate measured by the airflow sensor relative to a predetermined mass flow rate threshold.

3. The air filtration assembly of claim 2, wherein the feedback interface comprises a first light and a second light and is disposed proximate to the work tool.

4. The air filtration assembly of claim 3, wherein responsive to the mass flow rate measured by the airflow sensor being greater than or equal to the predetermined mass flow rate threshold, the feedback interface indicates a positive airflow status by illuminating the first light.

5. The air filtration assembly of claim 3, wherein responsive to the mass flow rate measured by the airflow sensor being less than the predetermined mass flow rate threshold, the feedback interface indicates a negative airflow status by illuminating the second light.

6. The air filtration assembly of claim 2, wherein responsive to the mass flow rate measured by the airflow sensor being less than the predetermined mass flow rate threshold, the processing circuitry automatically increases an operating speed of the motor.

7. The air filtration assembly of claim 2, wherein the feedback interface comprises a ring-shaped light and is disposed proximate to the intake.

8. The air filtration assembly of claim 7, wherein responsive to the mass flow rate measured by the airflow sensor being greater than or equal to the predetermined mass flow rate threshold, the feedback interface indicates a positive airflow status by illuminating the ring-shaped light with a first color.

9. The air filtration assembly of claim 8, wherein responsive to the mass flow rate measured by the airflow sensor being less than the predetermined mass flow rate threshold, the feedback interface indicates a negative airflow status by illuminating the ring-shaped light with a second color.

10. The air filtration assembly of claim 9, wherein the ring-shaped light shifts from the first color to the second color via a third color responsive to the mass flow rate measured by the airflow sensor decreasing below the predetermined mass flow rate threshold over time.

11. The air filtration assembly of claim 2, wherein the processing circuitry notifies a user to change the filter via a user interface responsive to the mass flow rate measured by the airflow sensor being less than the predetermined mass flow rate threshold.

12. The air filtration assembly of claim 1, wherein the airflow sensor is a thermal mass flow sensor.

13. The air filtration assembly of claim 1, wherein the work tool is a soldering tool.

14. An airflow monitoring assembly for an air filtration assembly for filtering gas or particles generated responsive to operation of a work tool, the airflow monitoring assembly comprising:
an airflow sensor that measures a mass flow rate of air entering an intake of the air filtration assembly, and
a feedback interface that indicates an airflow status based on the mass flow rate measured by the airflow sensor,
wherein processing circuitry disposed in the air filtration assembly determines the mass flow rate measured by the airflow sensor relative to a predetermined mass flow rate threshold.

15. The airflow monitoring assembly of claim 14, wherein the feedback interface comprises a ring-shaped light and is disposed proximate to the intake of the air filtration assembly.

16. The airflow monitoring assembly of claim 15, wherein responsive to the mass flow rate measured by the airflow sensor being greater than or equal to the predetermined mass flow rate threshold, the feedback interface indicates a positive airflow status by illuminating the ring-shaped light with a first color.

17. The airflow monitoring assembly of claim 16, wherein responsive to the mass flow rate measured by the airflow sensor being less than the predetermined mass flow rate threshold, the feedback interface indicates a negative airflow status by illuminating the ring-shaped light with a second color.

18. The airflow monitoring assembly of claim 17, wherein the ring-shaped light shifts from the first color to the second color via a third color responsive to the mass flow rate measured by the airflow sensor decreasing below the predetermined mass flow rate threshold over time.

19. The airflow monitoring assembly of claim 14, wherein the feedback interface comprises a first light and a second light and is disposed proximate to the work tool,
wherein responsive to the mass flow rate measured by the airflow sensor being greater than or equal to the predetermined mass flow rate threshold, the feedback interface indicates a positive airflow status by illuminating the first light, and
wherein responsive to the mass flow rate measured by the airflow sensor being less than the predetermined mass flow rate threshold, the feedback interface indicates a negative airflow status by illuminating the second light.

20. A work system comprising:
a work tool;
a workstation at which the work tool performs a work task; and
an air filtration assembly for filtering gas or particles generated responsive to operation of the work tool, the air filtration assembly comprising:
an intake repositionable relative to the work tool;
a housing operably coupled to the intake, the housing comprising a filter, a motor and processing circuitry;
an exhaust operably coupled to the housing; and
an airflow monitoring assembly operably coupled to the intake,
wherein the processing circuitry is configured to control the operation of the motor and the airflow monitoring assembly,
wherein air enters the air filtration assembly at the intake responsive to operation of the motor, before passing through the filter and exiting out the exhaust,
wherein the airflow monitoring assembly comprises:
an airflow sensor that measures a mass flow rate of the air entering the intake, and
a feedback interface that indicates an airflow status based on the mass flow rate measured by the airflow sensor.
